(19) United States
(12) Patent Application Publication
(10) Pub. No.: US 2026/0187925 A1
(43) Pub. Date: Jul. 2, 2026

(54) Systems and Methods for Directly Generating Splats from Three-Dimensional Image Data

(71) Applicant: Illuscio, Inc., Culver City, CA (US)

(72) Inventors: Thomas Matterson, Breaker Bay (NZ); Timothy Ebling, Woodinville, WA (US)

(73) Assignee: Illuscio, Inc., Culver City, CA (US)

(21) Appl. No.: 19/007,895

(22) Filed: Jan. 2, 2025

(51) Int. Cl. G06T 17/20; G06T 7/90

(52) U.S. Cl. CPC G06T 17/20; G06T 7/90

(57) ABSTRACT

A splat generation system directly generates splats to accurately represent a three-dimensional (3D) object or scene from existing 3D image data or 3D primitives of a different non-splat 3D format without multiple iterative passes through a neural network or machine learning process. The system receives the 3D primitives of the non-splat 3D format, selects a set of 3D primitives, generates one or more splats that form a first surface that matches a second surface formed by the set of 3D primitives with an acceptable amount of structural loss, and defines visual characteristics for the one or more splats to match visual characteristics across the surface formed by the set of 3D primitives with an acceptable amount of visual characteristic loss. The system present the one or more splats instead of the set of 3D primitives in response to a request to access the 3D object or scene.

### BACKGROUND

Gaussian splats provide an optimized format for representing three-dimensional (3D) objects. Gaussian splat representations of a 3D object are typically smaller in size relative to point cloud or mesh representations of the same 3D object as fewer Gaussian splats are needed to represent the shapes, features, and visual characteristics of the 3D object relative to points or meshes of the other 3D formats.

However, the generation of the Gaussian splats is computationally expensive and time consuming. A neural network or machine learning process iteratively generates different sets of Gaussian splats to compare against different images of a 3D object from different perspectives. The generated sets of Gaussian splats are discarded or refined until a set of Gaussian splats are found that represent the 3D object with an acceptable amount of loss. Each iteration may take multiple seconds and thousands of iterations may be needed to arrive at the final set of splats. Accordingly, there is a need for a faster and more efficient way to generate a splat representation of a 3D object without the iterative neural network or machine learning process.

### BRIEF DESCRIPTION OF THE DRAWINGS

FIG. 1 illustrates an example of directly generating splats from existing three-dimensional (3D) primitives of a non-splat 3D format in accordance with some embodiments presented herein.

FIG. 2 illustrates an example of directly generating splats from meshes and textures and in accordance with some embodiments presented herein.

FIG. 3 illustrates an example of directly generating an optimized set of splats from a mesh representation of a 3D object in accordance with some embodiments presented herein.

FIG. 4 illustrates an example of generating additional splats to match the shape and visual characteristics of a set of connected 3D meshes with an acceptable amount of structural loss and visual characteristic loss in accordance with some embodiments presented herein.

FIG. 5 presents a process for directly generating an optimized set of splats from a non-splat 3D representation in accordance with some embodiments presented herein.

FIG. 6 illustrates an example of using the direct generation of splats from a non-splat 3D representation of a 3D object to optimize the 3D object for presentation on different devices in accordance with some embodiments presented herein.

FIG. 7 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and associated methods for directly generating splats to accurately represent a three-dimensional (3D) object or scene from existing 3D image data or 3D primitives of a different non-splat 3D format. The direct generation of the splats involves defining splats based on positions and visual characteristics of existing point cloud points, meshes from a mesh representation of the 3D object, or 3D primitives of another non-splat 3D representation. The splat definition may source the positional data directly from the reference 3D primitives of the non-splat 3D representation and may source the visual characteristics from textures that are applied to and/or defined separately from the reference 3D primitives.

The direct generation of the splats enables the rapid generation of a 3D splat representation of a 3D object without the multiple iterative passes used by existing neural network or machine learning splat generation processes. More specifically, the direct generation of the splats accurately creates the shape, form, and visual appearance of a 3D object without generating different sets of splats in different passes and without comparing each generated set of splats against a loss function or a series of two-dimensional (2D) images until ultimately generating and detecting the generated set of splats that represent the 3D object with an acceptable amount of loss. Instead, the direct generation of the splats requires a single iteration to replace one or more existing 3D primitives of the non-splat 3D representation with splats that accurately create the splat representation of the 3D object with a fidelity that matches or minimally differs from the fidelity of the point cloud, mesh representation, or other 3D representation from which the splat representation is generated.

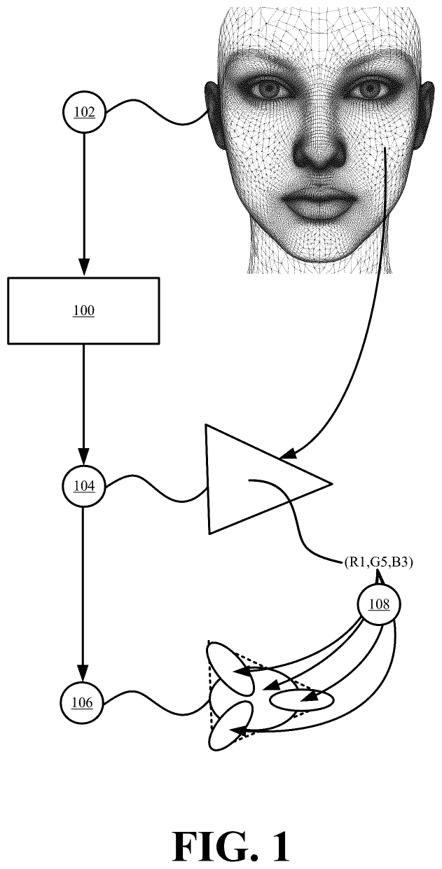

FIG. 1 illustrates an example of the direct generation of splats from existing 3D primitives of a non-splat 3D format in accordance with some embodiments presented herein. Splat generation system 100 receives (at 102) a mesh representation of a 3D object. The mesh representation may be generated by a graphical artist or by various 3D scanning or 3D imaging techniques. The mesh representation includes a connected a set of meshes or polygons that collectively form the shape and structure of the 3D object. Each mesh may be defined as a set of vertices with each vertex being associated with a set of coordinates for a position in 3D space.

Splat generation system 100 selects (at 104) a mesh from the mesh representation to directly convert to one or more splats. Splat generation system 100 may select (at 104) each mesh for conversion into one or more splats in a sequential manner based on the coordinates or positioning associated with each mesh.

Splat generation system 100 generates (at 106) a first splat at the center of the selected (at 104) mesh and additional splats at each vertex of the selected (at 104) mesh. The splats correspond to different 3D primitives than the meshes. For instance, the position of each splat may be defined with coordinates in a 3D space (e.g., x, y, and z values), a radius or shape, and/or a covariance. The splats may have an oval, ellipsoidal, cylindrical, conical, or other shape that spans a region or volume of the 3D space. The visual characteristics of the splat may include opacity and/or color parameters or spherical harmonics. The generated (at 106) splats may correspond to Gaussian splats or other splat definitions.

Splat generation system 100 generates (at 106) the splats to span the plane or shape of the selected (at 104) mesh. In generating (at 106) the splats, splat generation system 100 orients each splat based on the direction and/or angle of a normal defined for the selected (at 104) mesh and elongates the splat shape by adjusting the radius, shape, or covariance positional values until the generated (at 106) set of splats recreate or match the shape of the selected (at 104) mesh with an acceptable amount of loss.

In some embodiments, splat generation system 100 generates (at 106) fewer or more splats to represent the selected (at 104) mesh. For instance, splat generation system 100 generates (at 106) three splats at the vertices of a triangular mesh and adjusts the parameters of the splats to create the triangular mesh shape. In some embodiments, a configurable tolerance may specify how closely the generated (at 106) splats are to match the shape of the selected (at 104) mesh, and therefore increase or decrease the number of splats that are used to represent the shape of the selected (at 104) mesh.

Splat generation system 100 defines (at 108) the visual characteristics of the generated (at 106) splats to match or accurately recreate the visual characteristics of the selected (at 104) mesh with an acceptable amount of loss. When the mesh is defined with a single or uniform color, splat generation system 100 defines (at 108) the visual characteristics of the generated (at 106) splats with the single or uniform color of the selected (at 104) mesh. For instance, the selected (at 104) mesh may be defined with red, green, and blue color values, and splat generation system 100 may define (at 108) the color attributes or spherical harmonics of the generated (at 106) splats based on the red, green, and blue color values.

In some embodiments, the visual characteristics of the meshes may be defined using one or more textures. The textures may be applied to the meshes to vary the visual characteristics across the plane of each mesh or to provide other visual differentiation or variation across the mesh plane. In some embodiments, splat generation system 100 defines the visual characteristics of the one or more splats that are directly generated from a mesh using the visual characteristics from the texture that map to the mesh plane or surface.

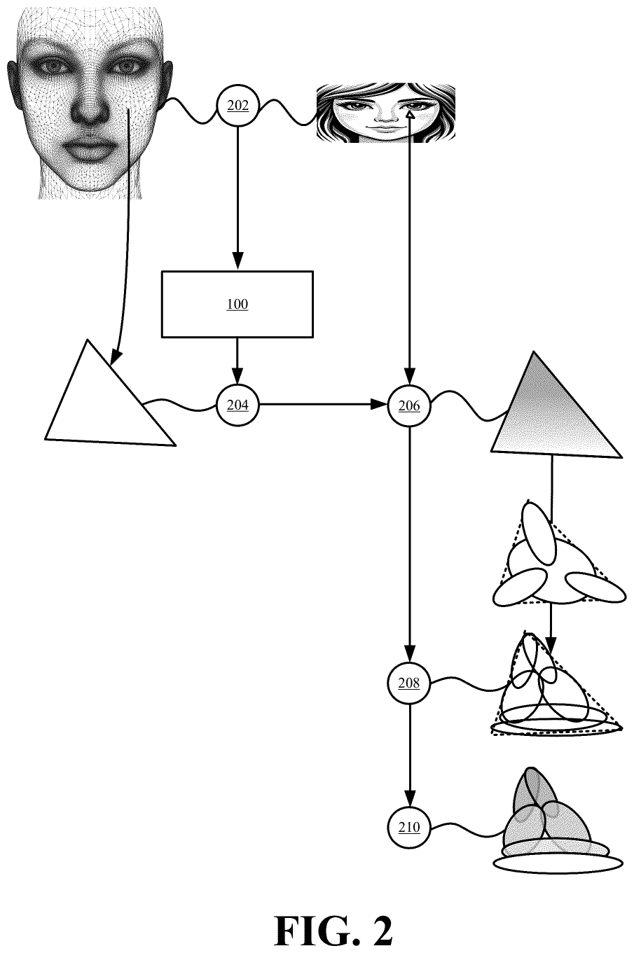

FIG. 2 illustrates an example of directly generating splats from meshes and textures and in accordance with some embodiments presented herein. Splat generation system 100 receives (at 202) a mesh representation of a 3D object and a texture that contains the coloring or visual characteristics to apply over the structure or surfaces created by the mesh representation.

Splat generation system 100 selects (at 204) a mesh from the mesh representation to directly convert to one or more splats. Splat generation system 100 determines (at 206) the visual characteristics from the texture that map to the surface or plane of the selected (at 204) mesh. In some embodiments, the texture may be a file with values ranging from 0 to 1 that index to or map to different color values. Splat generation system 100 may perform texture mapping or texture projection so that each point about the surface or plane of the selected (at 204) mesh is assigned a corresponding coordinate within the texture, and the visual characteristic value defined at the corresponding coordinate of the texture is projected or mapped back to the point about the surface or plane of the selected (at 204) mesh using a chosen projection methodology (e.g., planar, cylindrical, spherical, etc.).

Splat generation system 100 generates (at 208) one or more splats to represent or replace the selected (at 204) mesh based on the plane or shape of the selected (at 204) mesh and the variance or frequency of the visual characteristics from the texture that map to that plane or shape in the overall 3D object. For instance, if the visual characteristics mapping to the plane of the selected (at 204) mesh have a high or large variation (e.g., many different colors are mapped to the plane or surface of the selected (at 204) mesh), then splat generation system 100 may generate (at 208) more smaller-sized splats to recreate the shape of the selected (at 204) mesh. If the visual characteristic variation is low (e.g., a single color is mapped or the mapped colors differ by less than 5%), then splat generation system 100 may generate (at 208) fewer larger-sized splats to recreate the shape of the selected (at 204) mesh.

Splat generation system 100 defines (at 210) the visual characteristics of each generated (at 208) splat based on the portion of the mesh plane or surface spanned by that splat and the visual characteristics from the texture that map to that portion of the mesh plane or surface. Some variation in the visual characteristics may be captured using the spherical harmonics. However, if an exact match cannot be obtained, splat generation system 100 may approximate or average the visual characteristics over the portion of the mesh plane or surface spanned by a splat when defining (at 210) the splat visual characteristics.

In the above embodiments, splat generation system 100 may replace each mesh with one or more splats. The resulting splat representation may have a larger size than the original mesh representation that the splat representation is generated from. In some embodiments, splat generation system 100 may generate an optimized splat representation that is smaller in size than the original mesh representation without significant loss to the splat representation fidelity or quality.

In some such embodiments, splat generation system 100 uses the generated splat representation as training input for an optimization process. The optimization process may detect commonality in neighboring sets of splats and may replace the neighboring sets of splats with fewer larger sized splats so that the fidelity and appearance of the represented 3D object is preserved with less data (e.g., fewer splats). In other words, the generated splat representation provides the optimization process a starting point from which to immediately start the refinement iterations and skip the computationally expensive and time consuming iterations of a neural network or machine learning process that generates the different sets of splats until arriving at a set of splats that represent the 3D object with an acceptable amount of loss. The generated splat representation already represents the 3D object with the acceptable amount of loss. Accordingly, fewer iterations, less compute resources, and less time are needed for the optimization process to detect the commonality amongst the provided splats and to reduce the set of splats representing a region or part of the 3D object where there is a detected commonality.

In some other embodiments, splat generation system 100 optimizes the splat representation while directly generating the splats from the meshes or other non-splat 3D image data. In some such embodiments, splat generation system 100 does not generate one or more splats for each selected mesh. Instead, splat generation system 100 analyzes the positioning and visual characteristics of the meshes to determine neighboring groups of two or more meshes (e.g., two or more meshes that are connected to one another) with positional and visual characteristic commonality that may be represented by fewer splats or one splat. Since splats are planar or flat surfaces (not curved), detecting the positional commonality amongst a set of meshes includes detecting a set of meshes that are positioned about a common plane or that minimally deviate from the plane. Detecting the visual characteristic commonality includes detecting a neighboring group of two or more meshes that are defined with visual characteristics that deviate by less than a threshold amount from one another. For instance, a neighboring group of two or more meshes with visual characteristic commonality may include a first mesh with a first red color and a second mesh that is connected to the first mesh (e.g., shares one or more vertices with the first mesh) and has a second red color that differs from the first red color by less than 10%.

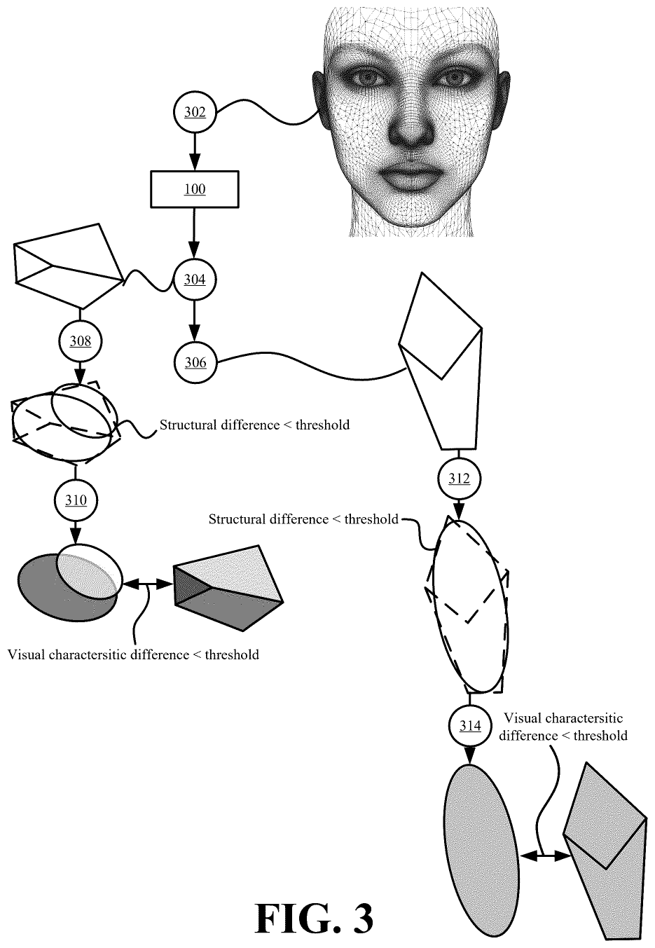

FIG. 3 illustrates an example of directly generating an optimized set of splats from a mesh representation of a 3D object in accordance with some embodiments presented herein. Splat generation system 100 receives (at 302) the mesh representation for conversion into an optimized splat representation, wherein the optimized splat representation is encoded with less total data and has a smaller file size than the mesh representation, and wherein the optimized splat representation still produces a visualization of the 3D object with equal or minimal loss as compared to a visualization that is generated from the mesh representation.

Splat generation system 100 analyzes the positions and visual characteristics of the meshes from the mesh representation for commonality. In particular, splat generation system 100 inspects the positions of neighboring or connected meshes to identify different sets of meshes that are positioned about a common plane or with positions that deviate from the common plane by less than a threshold amount. Splat generation system 100 then inspects the visual characteristics of each set of meshes that are positioned about a common plane to determine a subset of meshes from that set of meshes that have visual characteristics that differ by less than a threshold amount or that have a low variance in their respective visual characteristics. The visual characteristics may be defined in one or more textures, and may be applied or associated with the meshes via texture mapping or texture projection.

Splat generation system 100 detects and selects (at 304) a first set of connected meshes with a first positional and visual characteristic commonality, and detects and selects (at 306) a second set of connected meshes with a second positional and visual characteristic commonality. The first set of connected meshes includes three meshes that are oriented about a horizontal plane with some of three meshes deviating from the horizontal plane by no more than 5 degrees (e.g., a threshold amount). The three meshes of the first set of connected meshes have color values that differ by less than 10%. The second set of meshes includes two meshes that are oriented about a vertical plane and that have color values that differ by less than 5%.

Splat generation system 100 generates (at 308) two splats to recreate the overall shape that is formed by the first set of connected meshes with a specified amount of loss that is visually imperceptible. For instance, the two splats may create a first shape that is a 90% match to a second shape formed by the first set of connected meshes. From a distance, the difference between the first shape and the second shape is unnoticeable. In some embodiments, a user may set the amount of loss that is acceptable when generating the splat representation of the mesh representation. In some such embodiments, different amounts of loss may be specified for comparing the shape, form, or positioning of the generated splats to the represented meshes, and for comparing the visual characteristics (e.g., color, reflectivity, transparency, etc.) of the generated splats to the represented meshes. Splat generation system 100 orients the generated (at 308) splats according to the direction and/or angle of the normals associated with the first set of connected meshes.

Splat generation system 100 defines (at 310) the visual characteristics of the two splats to match the visual characteristics over the overall shape that is formed by the first set of connected meshes with a specified amount of loss. Defining (at 310) the visual characteristics may include determining the number of generated splats (e.g., 2) for the first set of connected meshes, determining mean, maximum, and minimum values for the visual characteristics of the first set of connected meshes, and defining different average visual characteristic values for the splats based on the determined number of generated splats and the determined mean, maximum, and minimum values. For instance, if a single splat is generated and the mean, maximum, and minimum values for the red color value are 105, 110, and 100, then the red color value for the single splat is 105. However, if two splats are generated and the red color value ranges from a minimum red color value of 100 to a maximum red color value of 110 from a first end of the first set of connected meshes to a second end, then splat generation system 100 may define the red color value of 103 for the first splat closest to and spanning from the first end, and may define the red color value of 107 of the second splat closest to and spanning from the second end. Splat generation system 100 may adjust the transparency or opacity of the splats to blend or mix colors or may define the spherical harmonics of each splat o produce a gradient effect in which the color changes at different parts of the splat.

Splat generation system 100 generates (at 312) a single splat to recreate the overall shape that is formed by the second set of connected meshes with a specified amount of loss. In this case, the shape of the single splat is a sufficiently accurate match to the shape formed by the second set of connected meshes.

Splat generation system 100 defines (at 314) the visual characteristics of the single splat to recreate the colors across the surface of the second set of connected meshes with a specified amount of loss. In this example, the second set of connected meshes are defined with a uniform color such that a single color defined for the single splat is sufficient to recreate the colors across the surface of the second set of connected meshes with the specified amount of loss.

Splat generation system 100 continues until a splat is generated and defined with visual characteristics for all meshes of the mesh representation, and until the generated splats recreate the shape, form, and visual characteristics of the mesh representation with an acceptable or configurable amount of loss. The optimized direct splat generation of FIG. 3 is completed in a single pass by first detecting the sets of meshes with positional and visual characteristic commonality and by replacing each set of meshes with one or more splats.

In some embodiments, the number of splats that are generated to create a shape or surface formed by a set of connected meshes with an acceptable amount of structural loss may be insufficient to represent the visual characteristic variations across that same shape or surface with an acceptable amount of visual characteristic loss. In some such embodiments, splat generation system 100 may increase the number of splats used to represent the shape or surface that is formed by the set of connected meshes (e.g., generate two splats instead of one splat to represent the overall shape) so that greater visual characteristic variation may be represented via the increased number of splats.

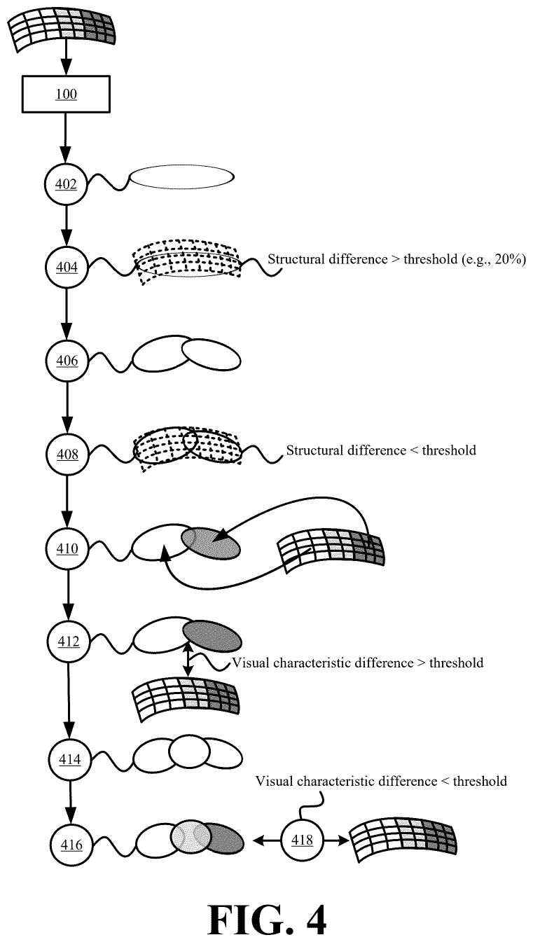

FIG. 4 illustrates an example of generating additional splats to match the shape and visual characteristics of a set of connected 3D meshes with an acceptable amount of structural loss and visual characteristic loss in accordance with some embodiments presented herein. Splat generation system 100 is tasked with converting a set of meshes that form a curved surface into splats.

Splat generation system 100 generates (at 402) a first splat to represent the curved surface. Splat generation system 100 compares (at 404) the shape of the first splat to the shape of the curved surface and determines that the shapes differ by more than an acceptable or threshold amount. In other words, the first splat does not represent the shape of the curved surface with a certain degree of accuracy.

Accordingly, splat generation system 100 generates (at 406) two splats to represent the curved surface. Once again, splat generation system 100 compares (at 408) the shape created by the two splats to the shape of the curved surface and determines that the shapes differ by less than the acceptable or threshold amount.

Splat generation system 100 defines (at 410) the visual characteristics for the two splats to match the visual characteristics defined for the set of meshes. Splat generation system 100 compares (at 412) the visual characteristics across the shapes created by the two splats to the visual characteristics across the curved surface formed by the set of meshes, and determines that the visual characteristics differ by more than the acceptable or threshold amount. In particular, the range of visual characteristics that may be represented across the two splats cannot replicate the range of visual characteristics that may be represented by the set of meshes within a threshold amount of accuracy.

Splat generation system 100 requires more splats to accurately represent the visual characteristics of the set of meshes. Accordingly, splat generation system 100 replaces (at 414) the two splats with three splats. The three splats better recreate the curved surface than the two splats so there is a gain in positional accuracy.

Splat generation system 100 defines (at 416) the visual characteristics for the three splats to match the visual characteristics defined for the set of meshes. Splat generation system 100 compares (at 418) the visual characteristics across the shapes created by the three splats to the visual characteristics across the curved surface formed by the set of meshes, and determines that the visual characteristics differ by less than the acceptable or threshold amount. Splat generation system 100 retains the three splats as the splat representation for the set of meshes since the three splats represent the shape or structure and the visual characteristics of the curved surface formed by the set of meshes with an acceptable amount of loss.

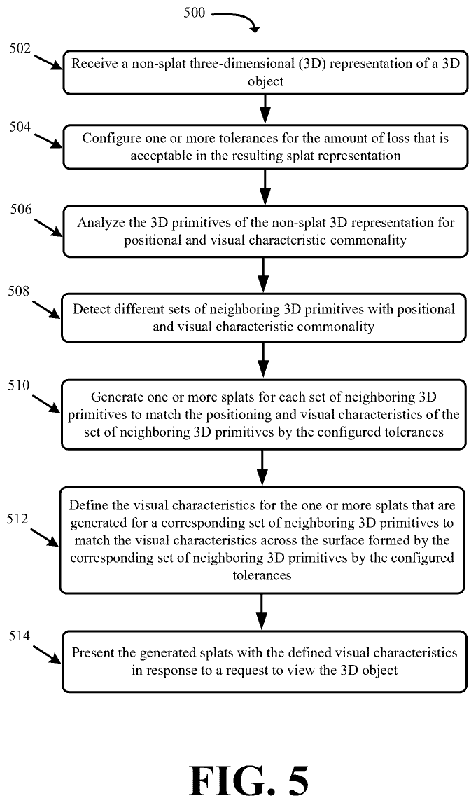

FIG. 5 presents a process 500 for directly generating an optimized set of splats from a non-splat 3D representation in accordance with some embodiments presented herein. Process 500 is implemented by splat generation system 100. Splat generation system 100 includes one or more devices or machines with processor, memory, storage, network, and/or other hardware resources that are adapted for or configured to generate the optimized splat representation of a 3D object from the non-splat 3D representation of the 3D object so that the splat representation is reduced in size and has comparable fidelity, quality, or detail relative to the non-splat 3D representation.

Process 500 includes receiving (at 502) the non-splat 3D representation of the 3D object. The non-splat 3D representation may be encoded as a point cloud with a disconnected and distributed set of points in a 3D space, may be encoded as a mesh representation with a connected set of meshes or polygons set in a 3D space, or may be encoded with other 3D primitives that reconstruct the shape and visual characteristics of the 3D object. Accordingly, the non-splat 3D representation is defined with a first set of 3D primitives (e.g., points, meshes, etc.). The non-splat 3D representation may also be defined with one or more textures that store the visual characteristic information (e.g., color, reflectivity, opacity, and/or other visual information) for the 3D primitives or that specify various transformations (e.g., bump map) to the surfaces created by the 3D primitives.

Process 500 includes configuring (at 504) one or more tolerances for the amount of loss that is acceptable in the splat representation that results from the direct conversion of the 3D primitives of the non-splat 3D representation. Different tolerances may be configured (at 504) for the acceptable structural loss and for the acceptable visual characteristic loss for the splat representation. For instance, a first tolerance may specify that the splat representation may have a 20% structural loss relative to the shape or structure of the non-splat 3D representation, and a 5% visual characteristic loss relative to the visual characteristics of the non-splat 3D representation. In some embodiments, configuring (at 504) the tolerances may include selecting between a high-quality, medium-quality, and low-quality representation, may include specifying a desired amount of data reduction when converting from the 3D primitives of the non-splat 3D representation to the splat of the splat representation, or may include specifying a desired total size for the splats of the splat representation. In some such embodiments, splat generation system 100 determines the tolerances based on the configured settings or values.

Process 500 includes analyzing (at 506) the 3D primitives of the non-splat 3D representation for positional and visual characteristic commonality. The analysis (at 506) includes inspecting the positional values of the 3D primitives to identify neighboring 3D primitives that are positioned about a common plane or that deviate from a common plane by less than a threshold amount (e.g., form a relative flat surface). The analysis (at 506) also includes inspecting the visual characteristics of the 3D primitives for an amount of variance between the identified neighboring 3D primitives that are positioned about a common plane. Accordingly, splat generation system 100 analyzes (at 506) the 3D primitives to identify sets of 3D primitives that form surfaces that are mostly or entirely flat as opposed to curved or jagged and that have low color frequency or variation.

Process 500 includes detecting (at 508) different sets of neighboring 3D primitives with positional and visual characteristic commonality. Each set of neighboring 3D primitives from the different sets of neighboring 3D primitives includes one or more 3D primitives with positions that deviate from a common plane by less than a first threshold amount and with visual characteristics that differ from one another by less than a second threshold amount.

Process 500 includes generating (at 510) one or more splats for each set of neighboring 3D primitives to match the positioning and visual characteristics of the set of neighboring 3D primitives by the configured (at 504) tolerances. For instance, splat generation system 100 generates (at 510) the minimum number of splats that recreates the shape or surface formed by a set of neighboring 3D primitives to within a configured (at 504) structural tolerance. In some embodiments, the configured (at 504) structural tolerance may specify an acceptable amount of loss between the shape created by the generated (at 510) splats and the shape created by the set of neighboring 3D primitives being represented by the generated (at 510) splats. In some such embodiments, splat generation system 100 generates (at 510) one splat and adjusts the radii of the splat to best conform with the shape created by the set of neighboring 3D primitives and performs a comparison to quantify the amount or percentage by which the shapes differ from one another. If the difference is within the configured (at 504) structural tolerance, the splat is retained. If the different is not within the configured (at 504) structural tolerance, splat generation system 100 increases the number of splats with which to recreate the shape formed by the set of neighboring 3D primitives. Splat generation system 100 may continue in this manner until there is a sufficient number of splats with which to create the shape that is formed by the set of neighboring 3D primitive within the configured (at 504) structural tolerance or an acceptable amount of loss specified by the configured (at 504) structural tolerance.

The generated (at 510) splats are defined with positional coordinates that span a portion of the common plane associated with the set of neighboring 3D primitives. The generated (at 510) splats are also oriented according to the direction or angle of the surface normal associated with the common plane or one or more of the set of neighboring 3D primitives. Accordingly, the surface normal may correspond to the surface normal that is associated with one or more 3D primitives from the set of neighboring 3D primitives or may correspond to the average of the surface normals that are associated with each 3D primitive from the set of neighboring 3D primitives.

Process 500 includes defining (at 512) the visual characteristics for the one or more splats that are generated (at 510) for a corresponding set of neighboring 3D primitives to match the visual characteristics across the surface formed by the corresponding set of neighboring 3D primitives by the configured (at 504) tolerances. In some embodiments, splat generation system 100 may render the surface based on the positional values and visual characteristics of the set of neighboring 3D primitives or based on the visual characteristics that are defined in one or more textures. Splat generation system 100 may determine the visual characteristics for different portions of the surface that are spanned by different splats of the generated (at 510) one or more splats, and may define (at 512) the visual characteristics of each splat to match the visual characteristics of the spanned portion of the surface. Since the spanned portion of the surface may have visual characteristic variation, splat generation system 100 may define (at 512) the visual characteristics of the splat based on the average or median visual characteristics of the spanned portion of the surface. Alternatively, splat generation system 100 may attempt to match the visual characteristic variation based on visual characteristic variations that may be represented by the spherical harmonics of the splats and/or by extending two or more splats over a common region and adjusting the transparency of the splats so that the colors of the two or more splats over the common region blend together. Defining (at 512) the visual characteristics may also include increasing the number of splats that are generated (at 510) for the corresponding set of neighboring 3D primitives when the defined (at 512) visual characteristics for the previously generated (at 510) one or more splats cannot match the visual characteristics across the surface formed by the corresponding set of neighboring 3D primitives by the configured (at 504) tolerances.

Process 500 includes presenting (at 514) the generated (at 510) splats with the defined (at 512) visual characteristics in response to a request to view the 3D object. Presenting (at 514) the splats may include streaming the splats instead of the 3D primitives of the non-splat representation over a data network to a requesting client device. Presenting (at 514) the splats may include rendering the lesser data of the optimized splats in order to generate a 3D visualization of the 3D object instead of the 3D primitives of the non-splat representation.

By directly generating the splats from 3D image data, splat generation system 100 may create splat representations of a 3D object at different levels-of-detail. Each splat representation at a different level-of-detail has a different size which makes the different splat representations optimal for streaming with different network performance. Similarly, each splat representation is optimized for rendering on devices with different rendering resources. For instance, by configuring the tolerances, splat generation system 100 may convert an original 3D mesh encoding of a 3D object into a first splat representation with a high first fidelity and a second splat representation with a low second fidelity. The first splat representation has less loss and more detail than the second splat representation because the first splat representation is defined or encoded with a larger number of smaller-sized splats than the second splat representation, wherein the greater number of smaller-sized splats more closely represent the structure, shape, and visual characteristics of the original 3D mesh encoding than the fewer number of larger-sized splats of the second splat representation. As a result, the first splat representation is encoded with more data and has a larger size than the second splat representation. Splat generation system 100 may select the first splat representation for distribution to client devices with high-bandwidth network connectivity or client devices with rendering resources capable of rendering the greater number of smaller-sized splats at a desired frame rate, and may select the second splat representation for distribution to client devices with low-bandwidth network connectivity or client devices with rendering resources that cannot render the greater number of smaller-sized splats at the desired frame rate.

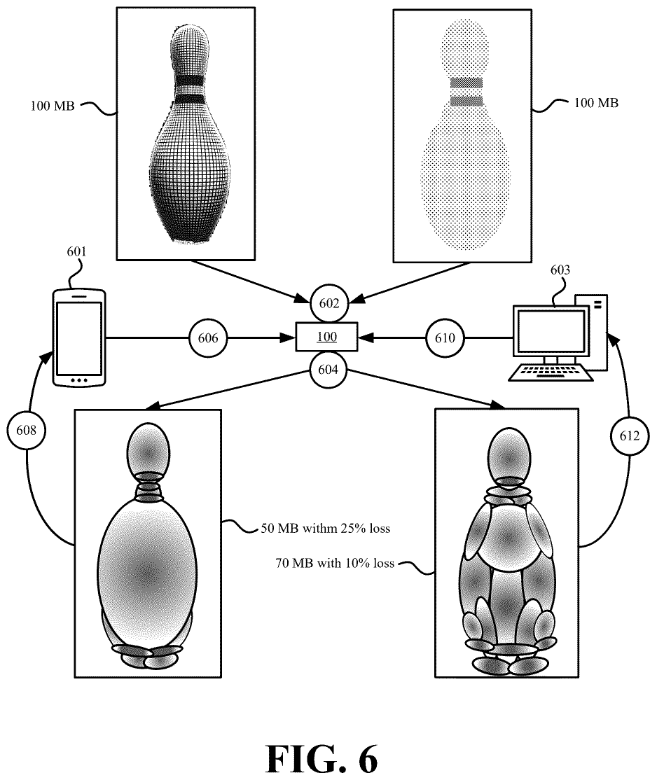

FIG. 6 illustrates an example of using the direct generation of splats from a non-splat 3D representation of a 3D object to optimize the 3D object for presentation on different devices in accordance with some embodiments presented herein. Splat generation system 100 receives (at 602) the non-splat 3D representation of the 3D object. In some embodiments, the non-splat 3D representation is defined or encoded with meshes to create a 3D mesh representation of the 3D object. In some other embodiments, the non-splat 3D representation is defined or encoded with points to create a point cloud representation of the 3D object.

Splat generation system 100 generates (at 604) different splats representations of the 3D object by converting the 3D primitives of the non-splat 3D representation into splats that represent the structures, shapes, and visual characteristics of those 3D primitives with differing levels-of-detail or loss. For instance, splat generation system 100 generates (at 604) a first splat representation with a first number of larger-sized splats to represent the 3D object with a 25% loss and a second splat representation with a second number of smaller-sized splats to represent the 3D object with 10% loss. The second number is greater than the first number and the second splat representation has a larger size and is encoded with more data than the first splat representation.

Splat generation system 100 receives (at 606) a first request from first client 601 to access or view the 3D object. The first request may include the name, Uniform Resource Locator (URL), directory path, or other identifier for accessing the 3D object, and may be issued as a HyperText Transfer Protocol (HTTP) GET message. The first request may specify a level-of-detail, fidelity, or resolution at which first client 601 wishes to receive the 3D object.

Splat generation system 100 presents (at 608) the first splat representation to first client 601 in response to determining the streaming and/or rendering resources associated with the first client or in response to the specified level-of-detail at which the 3D object is requested. For instance, splat generation system 100 may measure the latency or bandwidth over the network path connecting splat generation system 100 to first client 601 or may query first client 601 for its rendering resources (e.g., processor generation, graphics hardware accelerator, memory, etc.), and may determine that the second splat representation cannot be streamed or rendered without delay, buffering, and/or an interrupted experience given the network and/or rendering resources.

In some embodiments, presenting (at 608) the first splat representation includes streaming the splats of the first splat representation over a data network to first client 601. In some such embodiments, splat generation system 100 runs separate and remote from first client 601 and may be part of a content delivery service.

In some other embodiments, presenting (at 608) the first splat representation includes loading the splats of the first splat representation into a memory of first client 601. In some such embodiments, splat generation system 100 runs as part of a game engine or other rendering engine that is executed by first client 601. The rendering engine is tasked with rendering a 3D environment that includes the 3D object at a specified frame rate and uses splat generation system 100 to dynamically adjust the level-of-detail for the 3D object and other assets or content of the 3D environment so that the specified frame rate may be achieved with the hardware resources of first client 601.

Splat generation system 100 receives (at 610) a second request from second client 603 to access or view the 3D object. The second request may specify a level-of-detail, fidelity, or resolution that is greater than a first level-of-detail, fidelity, or resolution at which first client 601 requests the 3D object.

Splat generation system 100 presents (at 612) the second splat representation to second client 603 in response to determining the streaming and/or rendering resources associated with the second client are sufficient for the greater data associated with the second splat representation or in response to the specified level-of-detail at which the 3D object is requested in the second request. Accordingly, splat generation system 100 dynamically provides different clients with different splat representations at different levels-of-detail without having to downsample, upsample, or otherwise reencode the non-splat 3D representation from which the splat representations are generated. Moreover, splat generation system 100 generates the different splat representations without the computational overhead associated with neural networks, machine learning processes, and/or other splat generation techniques that require radiance fields, gradient descent, and/or other multiple iterative passes that generate multiple splat representations that are discarded after generating one splat representation that satisfies a loss function.

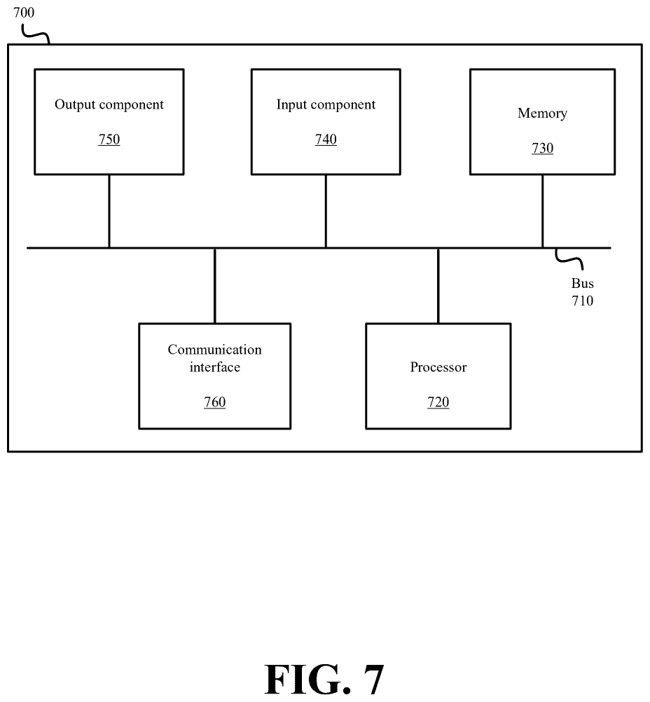

FIG. 7 is a diagram of example components of device 700. Device 700 may be used to implement one or more of the tools, devices, or systems described above (e.g., splat generation system 100, client devices 601 and 603, etc.). Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more LEDs, etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a plurality of three-dimensional (3D) primitives for a non-splat 3D representation of a 3D object;
selecting a set of 3D primitives from the plurality of 3D primitives;
generating one or more splats that form a first surface that matches a second surface formed by the set of 3D primitives with an acceptable amount of structural loss;
defining visual characteristics for the one or more splats to match visual characteristics across the second surface formed by the set of 3D primitives with an acceptable amount of visual characteristic loss; and
presenting the one or more splats instead of the set of 3D primitives in response to a request to access the 3D object.

2. The method of claim 1, wherein selecting the set of 3D primitives comprises:
determining two or more 3D primitives from the plurality of 3D primitives that are positioned next to one another and that deviate from a common plane by less than a first threshold amount.

3. The method of claim 2, wherein selecting the set of 3D primitives further comprises:
determining color variation across the two or more 3D primitives is less than a second threshold amount.

4. The method of claim 1, wherein generating the one or more splats comprises:
defining fewer splats to form the first surface than 3D primitives in the set of 3D primitives that form the second surface.

5. The method of claim 1, wherein each splat of the one or more splats has a varying ellipsoidal shape, and wherein each 3D primitive of the plurality of 3D primitives corresponds to a point of a point cloud or a mesh of a mesh representation.

6. The method of claim 1, wherein each splat of the one or more splats is defined with a position in a 3D space and one or more radii that adjust a shape of the splat, and wherein each splat spans a region of the first surface that is larger than a region of the second surface spanned by a single 3D primitive of the set of 3D primitives.

7. The method of claim 1 further comprising:
orienting each of the one or more splats according to a surface normal associated with the second surface or one or more of the set of 3D primitives.

8. The method of claim 1, wherein defining the visual characteristics comprises:
receiving a texture that is associated with the non-splat 3D representation;
mapping a set of visual characteristics from the texture to the second surface formed by the set of 3D primitives; and
defining the visual characteristics of each splat of the one or more splats based on a subset of visual characteristics from the set of visual characteristics that are mapped to a portion of the second surface that aligns with a portion of the first surface spanned by that splat.

9. The method of claim 1, wherein defining the visual characteristics comprises:
determining that the one or more splats are insufficient to recreate the visual characteristics across the second surface with the acceptable amount of visual characteristic loss;
generating a set of splats that form the first surface with more splats than the one or more splats; and
increasing visual characteristic variation across the first surface by defining the visual characteristics of the set of splats to match visual characteristics across the second surface formed by the set of 3D primitives with the acceptable amount of visual characteristic loss.

10. The method of claim 1, wherein presenting the one or more splats comprises:
streaming the one or more splats instead of the set of 3D primitives over a data network to a requesting client device.

11. The method of claim 1, wherein presenting the one or more splats comprises:
loading the one or more splats instead of the set of 3D primitives into memory of a device that renders a visualization of the 3D object.

12. The method of claim 1 further comprising:
generating a set of splats that form a third surface that matches the second surface formed by the set of 3D primitives by a different second acceptable amount of structural loss;
defining visual characteristics for the set of splats to match the visual characteristics across the second surface formed by the set of 3D primitives by a different second acceptable amount of visual characteristic loss; and
generating a first splat representation of the 3D object at a first fidelity with the one or more splats and a second splat representation of the 3D object at a second fidelity with the set of splats, wherein the second fidelity is greater than the first fidelity.

13. A splat generation system comprising:
one or more hardware processors configured to:
receive a plurality of three-dimensional (3D) primitives for a non-splat 3D representation of a 3D object;
select a set of 3D primitives from the plurality of 3D primitives;
generate one or more splats that form a first surface that matches a second surface formed by the set of 3D primitives with an acceptable amount of structural loss;
define visual characteristics for the one or more splats to match visual characteristics across the second surface formed by the set of 3D primitives with an acceptable amount of visual characteristic loss; and
present the one or more splats instead of the set of 3D primitives in response to a request to access the 3D object.

14. The splat generation system of claim 13, wherein selecting the set of 3D primitives comprises:
determining two or more 3D primitives from the plurality of 3D primitives that are positioned next to one another and that deviate from a common plane by less than a first threshold amount.

15. The splat generation system of claim 14, wherein selecting the set of 3D primitives further comprises:
determining color variation across the two or more 3D primitives is less than a second threshold amount.

16. The splat generation system of claim 13, wherein generating the one or more splats comprises:
defining fewer splats to form the first surface than 3D primitives in the set of 3D primitives that form the second surface.

17. The splat generation system of claim 13, wherein each splat of the one or more splats has a varying ellipsoidal shape, and wherein each 3D primitive of the plurality of 3D primitives corresponds to a point of a point cloud or a mesh of a mesh representation.

18. The splat generation system of claim 13, wherein each splat of the one or more splats is defined with a position in a 3D space and one or more radii that adjust a shape of the splat, and wherein each splat spans a region of the first surface that is larger than a region of the second surface spanned by a single 3D primitive of the set of 3D primitives.

19. The splat generation system of claim 13, wherein the one or more hardware processors are further configured to:
orient each of the one or more splats according to a surface normal associated with the second surface or one or more of the set of 3D primitives.

20. A non-transitory computer-readable medium storing instructions that, when executed by one or more processors of a splat generation system, cause the splat generation system to perform operations comprising:
receiving a plurality of three-dimensional (3D) primitives for a non-splat 3D representation of a 3D object;
selecting a set of 3D primitives from the plurality of 3D primitives;
generating one or more splats that form a first surface that matches a second surface formed by the set of 3D primitives with an acceptable amount of structural loss;
defining visual characteristics for the one or more splats to match visual characteristics across the second surface formed by the set of 3D primitives with an acceptable amount of visual characteristic loss; and
presenting the one or more splats instead of the set of 3D primitives in response to a request to access the 3D object.
